(19) United States
(12) Patent Application Publication
(10) Pub. No.: US 2011/0254232 A1
(43) Pub. Date: Oct. 20, 2011

(54) SEAL STRUCTURE FOR OIL DROP HOLE IN CYLINDER HEAD GASKET

(76) Inventors: Yasumaro Takeda, Aichi-ken (JP); Masanori Kusano, Aichi-ken (JP)

(21) Appl. No.: 12/998,973

(22) PCT Filed: Oct. 7, 2009
(86) PCT No.: PCT/JP2009/067464

§ 371 Date: Jun. 20, 2011

(30) Foreign Application Priority Data
Dec. 26, 2008 (JP) 2008-334237

(51) Int. Cl. F02F 11/00; F16J 15/06

(52) U.S. Cl. 277/591

(57) ABSTRACT

A cylinder head gasket 1 includes at least two first and second seal plates 11 and 12 in which oil drop holes 4 are perforated, respectively. On the first and second seal plates, half beads 11a and 12a that endlessly surround the oil drop holes and that project in a direction toward each other to be mutually pressed are formed, and the oil drop holes are sealed by these half beads. Outside of the respective half beads, auxiliary beads 11c and 12c that project in a direction toward each other to be mutually pressed are formed. Projection directions of the half beads and the auxiliary beads may be opposite to each other. Since the respective auxiliary beads 11c and 12c give acting forces that press the respective half beads 11a and 12a against a cylinder head or a cylinder block, a better sealing property can be secured as compared with a conventional cylinder head gasket.

### TECHNICAL FIELD

The present invention relates to a cylinder head gasket and, more particularly, to a seal structure for sealing oil drop holes provided in the cylinder head gasket.

### BACKGROUND ART

Conventionally, a cylinder head gasket including at least two seal plates has been well-known, and for example, a cylinder head gasket described in Patent Literature 1 includes three seal plates.

It has also been conventionally well-known that an engine includes oil drop holes, and oil drop holes are formed also in the three seal plates, respectively although not described in Patent Literature 1. Additionally, this oil drop hole is formed in the respective seal plates to be sealed by a half bead that endlessly surrounds the oil drop hole.

It is to be noted that a gasket has been conventionally well-known in which a full bead and a half bead surrounding an exhaust passage are concentrically formed in one seal plate as a gasket for an exhaust manifold (FIG. 3 in Patent Literature 2).

### PRIOR ART DOCUMENTS

### Patent Literature

Patent Literature 1: Japanese Patent Laid-Open No. 2007-247631

Patent Literature 2: Japanese Patent Laid-Open No. 8-232759

### SUMMARY OF INVENTION

### Problems to be Solved by the Invention

By the way, a cylinder head gasket is generally held between a cylinder head and a cylinder block by fastening the cylinder head and the cylinder block with fastening bolts.

At this time, a space between the cylinder head and the cylinder block becomes gradually larger toward an outside of an engine with the fastening bolts being as base points.

Although an endless half bead is provided around an oil drop hole to seal the oil drop hole in the cylinder head gasket in Patent Literature 1, when an opening amount between the cylinder head and the cylinder block becomes larger, an adhesion force of the half bead with the cylinder head or the cylinder block becomes smaller, and thereby oil leakage occurs.

Hence, conventionally, in an engine in which an opening amount between the cylinder head and the cylinder block outside the engine is large, it has been necessary to increase the number of seal plates according to the opening amount, causing increase of cost.

In view of such circumstances, the present invention provides a seal structure for an oil drop hole in a cylinder head gasket in which an adhesion force of a half bead with a cylinder head or a cylinder block can be increased to thereby improve sealing performance without increasing the number of seal plates.

### Means for Solving the Problems

Namely, the invention of claim 1 provides a seal structure for an oil drop hole in a cylinder head gasket including at least two first and second seal plates in which the oil drop holes are respectively perforated, wherein

on the first and second seal plates, half beads that endlessly surround the oil drop holes and that project in a direction toward each other to be mutually pressed are formed, and

outside of the respective half beads, auxiliary beads that project in a direction toward each other to be mutually pressed are further formed.

In addition, the invention of claim 5 provides a seal structure for an oil drop hole in a cylinder head gasket including at least two first and second seal plates in which the oil drop holes are respectively perforated, wherein

at a position overlapping with each other on the first and second seal plates, half beads that project in a direction away from each other to endlessly surround the oil drop holes are respectively formed, and

auxiliary beads that project in a direction away from each other are formed at a position overlapping with each other outside of the respective half beads.

### Advantageous Effects of Invention

When the cylinder head and the cylinder block are coupled to each other with fastening bolts which are not shown, in a state where the cylinder head gasket having the above-described configuration is held between the upper cylinder head and the lower cylinder block, a top portion of the upper half bead is made to adhere strongly to the cylinder head, and a top portion of the lower half bead is made to adhere strongly to the cylinder block. As a result of this, the oil drop holes are endlessly surrounded by the respective top portions of the respective half beads to thereby be sealed.

Simultaneously, when the auxiliary bead is held between the cylinder head and the lower cylinder block, the top portion of the upper half bead is subjected to an acting force to be pushed up by the auxiliary bead, and the top portion of the lower half bead is also subjected to an acting force to be pushed down by the auxiliary bead.

Consequently, even though a space between the cylinder head and the cylinder block becomes gradually larger toward an outside of an engine with the fastening bolts being as base points when the cylinder head and the cylinder block are fastened by the fastening bolts, the respective top portions of the respective half beads are successfully made to adhere to the cylinder head or the cylinder block by the acting force, thus enabling to secure a better sealing property as compared with a conventional cylinder head gasket.

### BRIEF DESCRIPTION OF DRAWINGS

FIG. 1 is a plan view showing a first embodiment of the present invention.

FIG. 2 is an enlarged plan view of a main part of FIG. 1.

FIG. 3 is a cross-sectional view taken along a line of FIG. 2.

FIG. 4 is a cross-sectional view showing a second embodiment of the present invention.

FIG. 5 is an analysis result graph illustrating advantageous effects of the present invention.

FIG. 6 is a cross-sectional view showing a third embodiment of the present invention.

FIG. 7 is a cross-sectional view showing a fourth embodiment of the present invention.

FIG. 8 is a cross-sectional view showing a fifth embodiment of the present invention.

FIG. 9 is a cross-sectional view showing a sixth embodiment of the present invention.

FIG. 10 is a cross-sectional view showing a seventh embodiment of the present invention.

FIG. 11 is a cross-sectional view showing an eighth embodiment of the present invention.

FIG. 12 is a cross-sectional view showing a ninth embodiment of the present invention.

### MODE FOR CARRYING OUT THE INVENTION

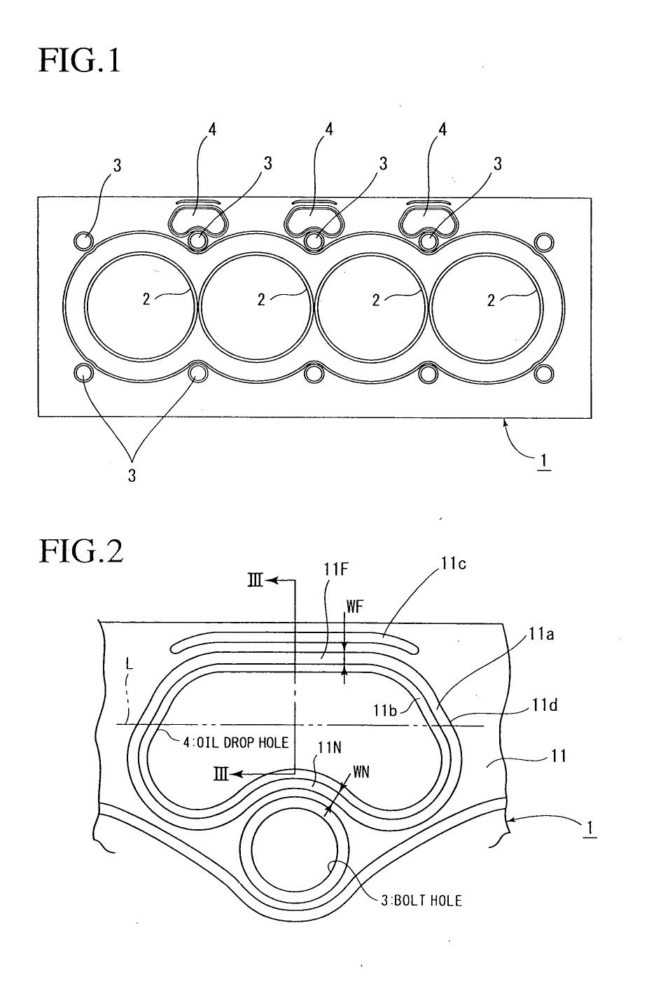

When embodiments of the present invention shown in drawings will be described hereinafter, in FIG. 1, a cylinder head gasket 1 of the embodiment includes: four combustion chamber holes 2 arranged in line; a plurality of bolt holes 3 through which fastening bolts, which are not shown, are inserted; and a plurality of oil drop holes 4.

Since the bolt holes 3 are arranged so as to surround the respective combustion chamber holes 2 at four points, but the bolt holes 3 between the adjacent combustion chamber holes 2 and 2 are provided in common to both the combustion chamber holes 2 and 2, the bolt holes 3 are formed at a total of ten points.

In addition, the oil drop holes 4 are provided at three points on one side of a longitudinal direction of the cylinder head gasket 1, and on the outsides of the respective three bolt holes 3 provided in common to the adjacent combustion chamber holes 2 and 2 (on an opposite side to the combustion chamber holes).

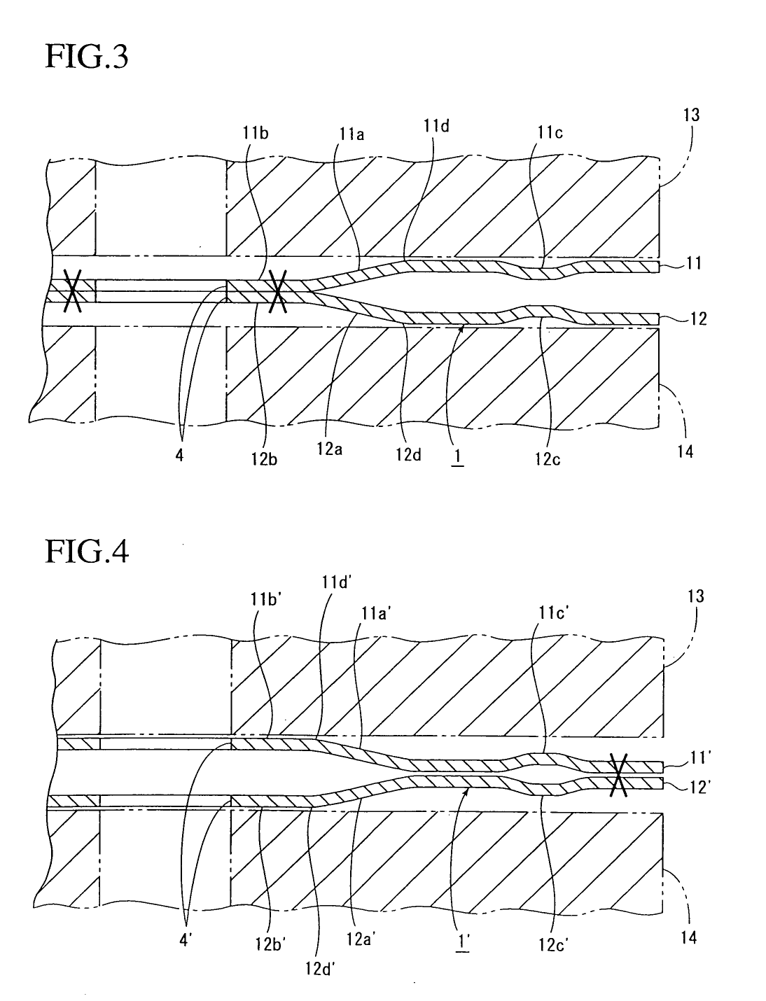

The cylinder head gasket 1 includes metallic first and second seal plates 11 and 12 as shown in FIG. 3, and both the seal plates 11 and 12 are held between a cylinder head 13 and a cylinder block 14 to seal a space therebetween.

The oil drop holes 4 are perforated in the seal plates 11 and 12, respectively, and it goes without saying that the bolt holes 3 and the combustion chamber holes 2 are also perforated although not shown in FIG. 3.

Half beads 11a and 12a that endlessly surround the oil drop holes 4 are formed, respectively in the respective seal plates 11 and 12 in order to seal the oil drop holes 4.

The first half bead 11a formed in the upper first seal plate 11 of a cylinder head 13 side projects toward the lower second seal plate 12, and the second half bead 12a formed in the lower second seal plate 12 of a cylinder block 14 side projects toward the upper first seal plate 11.

Hence, both the half beads 11a and 12a project in a direction toward each other, and surrounded portions 11b and 12b around the oil drop holes 4 surrounded by the respective half beads 11a and 12a are in contact with each other.

A portion 11F of the both half beads 11a and 12a far from the bolt hole 3 shown in FIG. 2 projects more than a portion 11N near the bolt hole 3, whereby it is configured that the far portion 11F of the respective half beads 11a and 12a can follow an opening between the cylinder head 13 and the cylinder block 14 with an adhesion force larger than that in the near portion 11N.

More specifically, the far portion 11F of the respective half beads 11a and 12a is formed projecting more than the near portion 11N with a virtual line L being as a border in the embodiment shown in FIG. 2, and a large projection amount of the far portion 11F and a small projection amount of the near portion 11N are formed to smoothly continue to each other in the virtual line L portion.

It is to be noted that a width WF of the far portion 11F of the respective half beads 11a and 12a is formed to be larger than a width WN of the near portion 11N instead of changing the projection amounts of the far portion 11F and the near portion 11N, and thereby follow property of the far portion 11F for the opening between the cylinder head 13 and the cylinder block 14 may be made to be larger than that of the near portion 11N.

At this time, the width WF of the far portion 11F may be formed larger than the width WN of the near portion 11N at the same time as the projection amount of the far portion 11F is made to be larger than that of the near portion 11N, and further, the above-described each setting may be provided in at least any of the half beads.

Further, in the respective seal plates 11 and 12, as shown in FIGS. 2 and 3, auxiliary beads 11c and 12c are formed along the half beads 11a and 12a, respectively at a position outside the respective half beads 11a and 12a and at the position of an opposite side of the bolt hole 3, i.e., at the position outside the cylinder head gasket 1 than the oil drop hole 4,

A cross section of the respective auxiliary beads 11c and 12c is formed to be circular in the embodiment, the first auxiliary bead 11c formed in the upper first seal plate 11 projects toward the lower second seal plate 12, and the second auxiliary bead 12c formed in the lower second seal plate 12 projects toward the upper first seal plate 11.

Hence, both the auxiliary beads 11c and 12c project in a direction toward each other to thereby mutually adhere.

In addition, in the embodiment, the surrounded portions 11b and 12b around the oil drop hole 4 are coupled with welding, adhesive, etc. as shown with a x mark in FIG. 3. This coupled portion may be provided at a plurality of portions around the oil drop hole 4, or may be continuously endlessly formed.

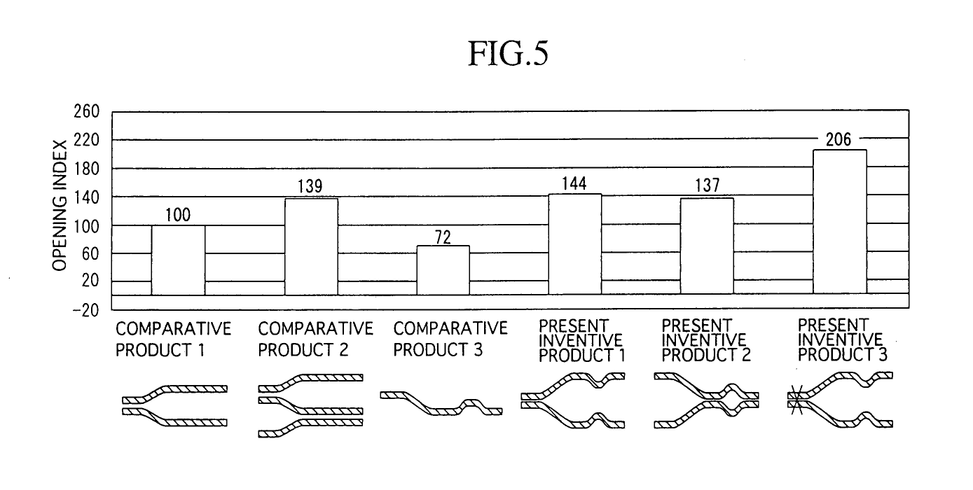

When both the seal plates 11 and 12 are held between the cylinder head 14 and the cylinder block 14, an inner peripheral portion of the oil drop hole 4 of the respective seal plates 11 and 12 is enlarged, but the enlargement can be suppressed when a surrounding area of the oil drop hole 4 is coupled as mentioned above, thus enabling to further improve the sealing property as shown with an analysis result in FIG. 5, which will be described hereinafter.

It is to be noted that the present invention is not concerned with a configuration for sealing the combustion chamber hole 2, and that a conventionally well-known suitable configuration can be employed as the sealing configuration.

For example, such a configuration can be used that full beads, which will not be shown, that endlessly surround the combustion chamber hole 2 are formed in a direction away from each other in the respective seal plates 11 and 12, and that a shim plate for increasing a surface pressure around the combustion chamber hole 2 are arranged between the full beads.

In the above-described configuration, when the cylinder head 13 and the cylinder block 14 are coupled to each other with a fastening bolt, which is not shown, in a state where the cylinder head gasket 1 is held between the cylinder head 13 and the cylinder block 14, a top portion 11d of the upper half bead 11a is made to adhere strongly to the cylinder head 13, and a top portion 12d of the lower half bead 12a is made to adhere strongly to the cylinder block 13. As a result of this, the oil drop hole 4 is endlessly surrounded particularly by the respective top portions 11d and 12d of the respective half beads 11a and 12a to thereby be sealed.

Simultaneously, the auxiliary beads 11c and 12c are also pressed against each other. The top portion 11d of the upper half bead 11a is then subjected to an acting force to be pushed up by the lower auxiliary bead 12c, and the top portion 12d of the lower half bead 12a is subjected to an acting force to be pushed down by the upper auxiliary bead 11c.

Consequently, when the cylinder head 13 and the cylinder block 14 are fastened by the fastening bolt, even though a space between the cylinder head 13 and the cylinder block 14 becomes gradually larger toward the outside of the engine with the fastening bolt being as the base point, the respective top portions 11d and 12d of the respective half beads 11a and 12a are successfully made to adhere to the cylinder head 13 or the cylinder block 14 by the acting force, thus enabling to secure a better sealing property as compared with the conventional cylinder head gasket.

FIG. 4 shows a second embodiment of the present invention, and a projection direction of the half beads 11a and 12a and that of the auxiliary beads 11c and 12c in the above-mentioned first embodiment are set to be reversed in the second embodiment.

Namely, in the second embodiment, a first half bead 11a′ formed in an upper first seal plate 11′ of the cylinder head 13 side upwardly projects toward the cylinder head 13 side, and a second half bead 12a′ formed in a lower second seal plate 12′ of the cylinder block 14 side downwardly projects toward the cylinder block 14. Hence, both the half beads 11a′ and 12a′ project in a direction away from each other.

On the other hand, a first auxiliary bead 11c′ formed in the upper first seal plate 11′ upwardly projects toward the cylinder head 13 side, and a second auxiliary bead 12c′ formed in the lower second seal plate 12′ downwardly projects toward the cylinder block 14. Hence, both the auxiliary beads 11c′ and 12c′ also project in a direction away from each other.

Further, in the embodiment, the first and second seal plate 11′ and 12′ are coupled to each other with welding, adhesive, etc. at a position outside the auxiliary beads 11c′ and 12c′ as shown with a x mark in FIG. 4. This coupled portion may be provided at a plurality of portions at a position outside the auxiliary beads 11c′ and 12c′, or may be continuously linearly formed.

When both the seal plates 11 and 12 are held between the cylinder head 14 and the cylinder block 14, outside portions of the respective seal plates 11 and 12 are enlarged by making both the auxiliary beads 11c′ and 12c′ adhere to each other, but the enlargement can be suppressed when the outside portions are coupled, thus enabling to further improve the sealing property.

Other configurations are configured similar to the first embodiment, and portions equal to the first embodiment are indicated by applying “′” to symbols used in the first embodiment.

In the above-described configuration of the second embodiment, when the cylinder head 13 and the cylinder block 14 are coupled to each other with a fastening bolt, which is not shown, in a state where the cylinder head gasket 1′ is held between the cylinder head 13 and the cylinder block 14,

a top portion 11d′ of the upper half bead 11a′ is subjected to an acting force to be pushed up by the upper auxiliary bead 11c′, and a top portion 12d′ of the lower half bead 12a′ is subjected to an acting force to be pushed down by the lower auxiliary bead 12c′.

Consequently, the respective top portions 11d and 12d of the respective half beads 11a and 12a are successfully made to adhere to the cylinder head 13 or the cylinder block 14 by the acting force, thus enabling to secure a better sealing property as compared with the conventional cylinder head gasket.

FIG. 5 is an analysis result graph showing action effects of the present invention using 2DCAE.

Generally, when a temperature of the engine is raised, a space between the cylinder head 13 and the cylinder block 14 (an opening amount) in an outside portion of the engine is enlarged, and therefore, it was analyzed in the analysis that until what opening amount a sealing property of the oil drop hole 4 can be secured when gradually increasing the opening amount. Opening index sealing performance in FIG. 5 is a relative index indicating that until what opening amount the present inventive products could secure a sealing property when an opening amount was set to be 100 at the time of a sealing property of a comparative product 1 corresponding to conventional technology having been impaired.

A present inventive product 3 used for this analysis has a configuration shown in FIG. 3, and a present inventive product 1 is the product in which a coupling portion is omitted from the present inventive product 3, and in which the two seal plates 11 and 12 are simply overlapped with each other. In addition, a present inventive product 2 has a configuration shown in FIG. 4, and the coupling portion thereof is also omitted. Further, projection amounts and widths of the respective half beads 11a, 11a′, 12a, and 12a′ are not changed in any present inventive products 1 to 3, and they are set to be constant.

On the other hand, the comparative product 1 is the product using two seal plates, and it is made by simply forming only the half beads 11a and 12a in the two seal plates 11 and 12 shown in FIG. 3. Namely, comparative products including comparative products described hereinafter do not include the coupling portion, and projection amounts and widths of the half beads are set to be constant.

A comparative product 2 is the product using three seal plates, and it is made by adding one seal plate under the two seal plates in the present inventive product shown in FIG. 3 to make a half bead of the added seal plate project downwardly. Additionally, the auxiliary beads 11c and 12c are omitted in these three seal plates. Such configuration corresponds to the above-described configuration of Patent Literature 1.

Further, a comparative product 3 is the product using the only one seal plate 11. This configuration is the configuration in which the seal plate of the above-described Patent Literature 2 shown in FIG. 3 is used as a cylinder head gasket by reversing a sealing side. Namely, although the seal plate of Patent Literature 2 shown in FIG. 3 is used to seal an exhaust passage on the right side thereof, the seal plate of Patent Literature 2 shown in FIG. 3 is used to seal the oil drop hole on the right side thereof in this analysis.

As is apparent from the analysis result in FIG. 5, although the present inventive products 1 and 2 have only a few seal plates, i.e., two seal plates, respectively, a sealing property can be obtained until the opening amount reaches 144 or 137. Namely, as for the opening amount, 44% and 37% of improvement of sealing action can be obtained with respect to the comparative product 1 having the same number of seal plates as the present inventive products 1 and 2.

In addition, as compared with the comparative product 2 having three seal plates, although the present inventive products 1 and 2 have only a few seal plates, i.e., two seal plates, respectively, an approximately equal sealing property can be obtained.

Further, the best sealing property has been obtained in the present inventive product 3 in which the surrounding area of the oil drop hole 4 is fixed, and thus a sealing property far superior to the comparative products 1 and 2 can be obtained.

It is to be noted that as for the comparative product 3, only 72% of sealing property could be secured also with respect to the comparative product 1.

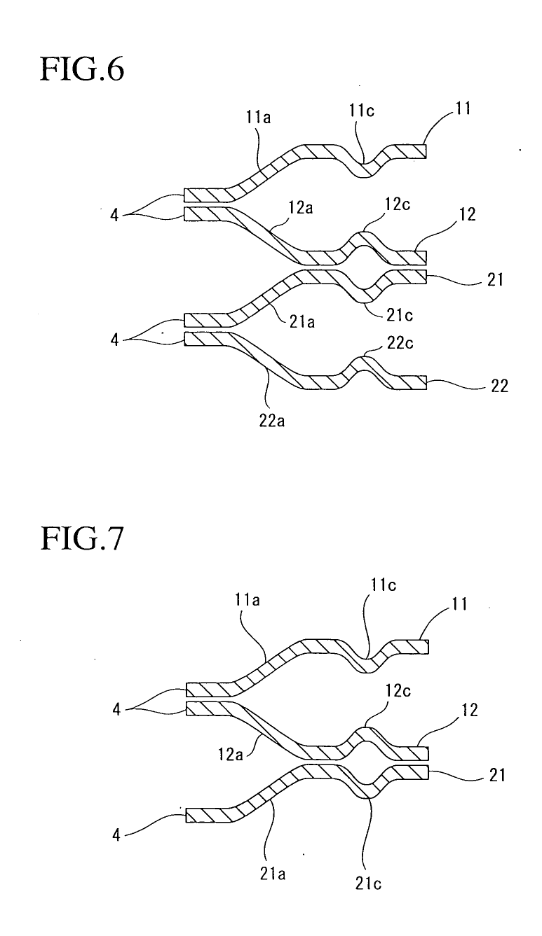

FIG. 6 shows a third embodiment of the present invention. Although two seal plates 11 and 12 are used in the above-described first embodiment, four seal plates 11, 12, 21, and 22 overlapped with one another are used in the embodiment.

In the embodiment, two seal plates 11 and 12 respectively have the same configuration as the above-mentioned first embodiment, the third seal plate 21 has the same configuration as the above-described first seal plate 11, and the fourth seal plate 22 has the same configuration as the second seal plate 12.

Namely, the third embodiment has a configuration in which the two seal plates 11 and 12 in the first embodiment are made into one set, and two sets thereof are overlapped with each other.

Action effects equal to the above-described first embodiment can be obtained also in the embodiment, and particularly in the third embodiment, the sealing property of the oil drop hole can be successfully secured also in an engine having a larger opening amount than in the first embodiment.

FIG. 7 shows a fourth embodiment of the present invention, in which the fourth seal plate 22 is omitted among the four seal plates 11, 12, 21, and 22 in the above-described third embodiment.

Namely, the fourth embodiment has a configuration in which the third seal plate 21 in which the oil drop hole 4 is perforated is overlapped with the second seal plate 12 in the above-described first embodiment, and a half bead 21a and an auxiliary bead 21c formed in this third seal plate 21 are formed at a position overlapping with the half bead 12a and the auxiliary bead 12c of the second seal plate 12 so as to project in a direction away from the half bead 12a and the auxiliary bead 12c of the second seal plate 12.

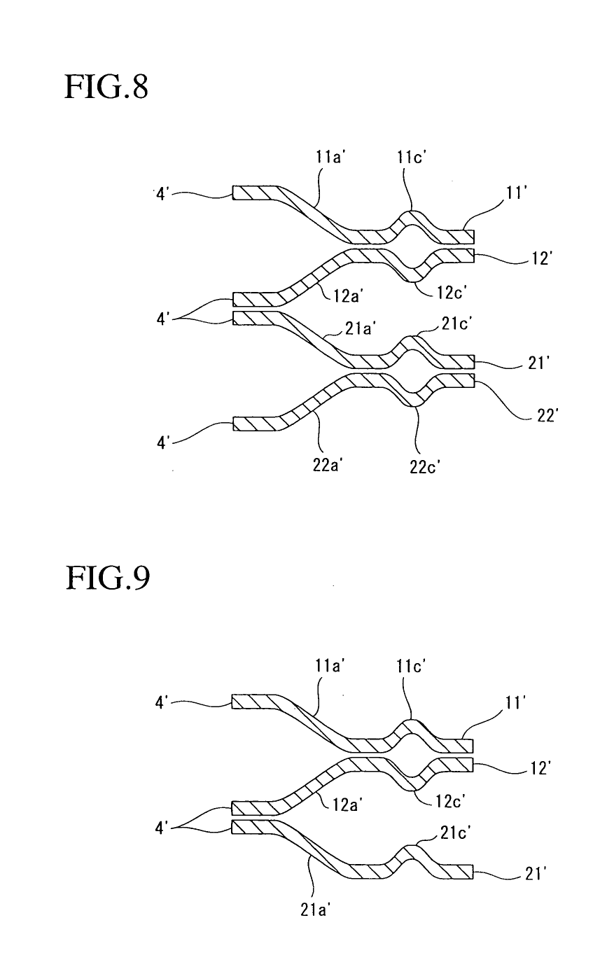

FIG. 8 shows a fifth embodiment of the present invention. Although two seal plates 11′ and 12′ are used in the above-described second embodiment, four seal plates 11′, 12′, 21′, and 22′ overlapped with one another are used in the embodiment.

In the embodiment, the two seal plates 11′ and 12′ respectively have the same configuration as the above-mentioned second embodiment, the third seal plate 21′ has the same configuration as the above-described first seal plate 11′, and the fourth seal plate 22′ has the same configuration as the second seal plate 12′.

Namely, the fifth embodiment has a configuration in which the two seal plates 11′ and 12′ in the second embodiment are made into one set, and two sets thereof are overlapped with each other.

Action effects equal to the above-described second embodiment can be obtained also in the embodiment, and particularly in the fifth embodiment, the sealing property of the oil drop hole can be successfully secured also in an engine having a larger opening amount than the second embodiment.

FIG. 9 shows a sixth embodiment of the present invention, in which the fourth seal plate 22′ is omitted among the four seal plates 11′, 12′, 21′, and 22′ in the above-described fifth embodiment.

Namely, the sixth embodiment has a configuration in which the third seal plate 21′ in which an oil drop hole 4′ is perforated is overlapped with the second seal plate 12′ in the above-described second embodiment, and a half bead 21a′ and an auxiliary bead 21c′ formed in this third seal plate 21′ are formed at a position overlapping with the half bead 12a′ and the auxiliary bead 12c′ of the second seal plate 12′ so as to project in a direction toward the half bead 12a′ and the auxiliary bead 12c′ of the second seal plate 12′.

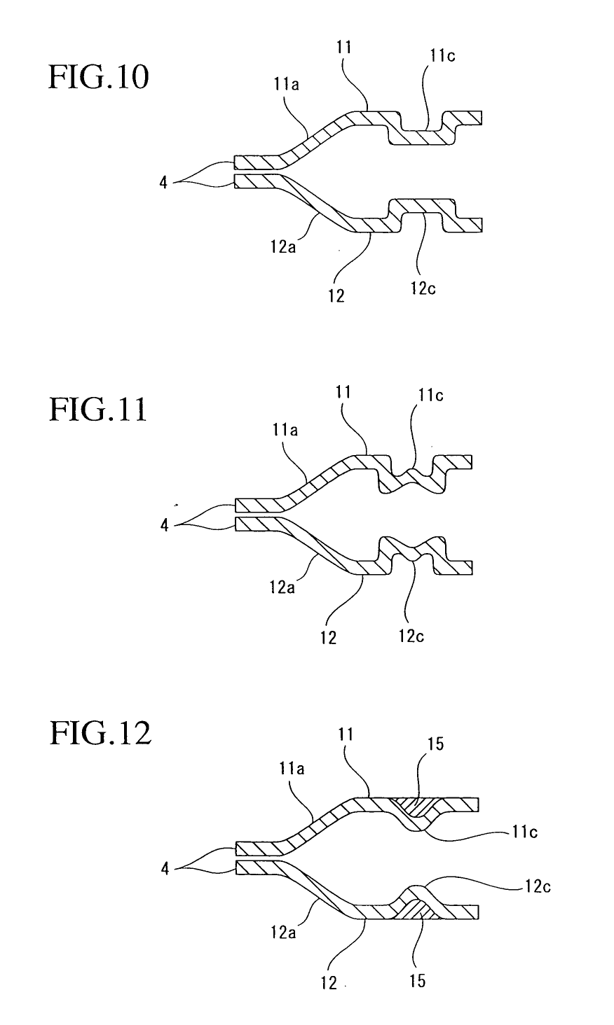

It is to be noted that cross sections of the respective auxiliary beads 11c and 12c are formed to be semicircular in the above-mentioned all embodiments, but they are not limited to this form. For example, the cross sections may be formed to be U-shaped as shown in FIG. 10, or may be formed to be M-shaped as shown in FIG. 11.

In addition, as shown in FIG. 12, an inside of the auxiliary bead is filled with a filling material 15, such as a resin or rubber, to suppress sag of the each auxiliary bead also in the above-mentioned all embodiments.

Further, although each auxiliary bead is formed only at the outside portion of the cylinder head gasket outside the oil drop hole in the above-described each embodiment, the auxiliary bead may be endlessly formed surrounding the oil drop hole and the half bead.

### REFERENCE SIGNS LIST

1 Cylinder head gasket
2 Combustion chamber hole
3 Bolt hole
4 Oil drop hole
11, 11′, 12, 12′, 21, 21′, 22, 22′ Seal plate
11a, 11a′, 12a, 12a′ Half bead
11c, 11c′, 12c, 12c′ Auxiliary bead
13 Cylinder head
14 Cylinder block
15 Filling material

1. A seal structure for an oil drop hole in a cylinder head gasket comprising at least two first and second seal plates in which the oil drop holes are respectively perforated, wherein
on the first and second seal plates, half beads that endlessly surround the oil drop holes and that project in a direction toward each other to be mutually pressed are formed, and
outside of the respective half beads, auxiliary beads that project in a direction toward each other to be mutually pressed are further formed.

2. The seal structure according to claim 1, wherein
third and fourth seal plates in which oil drop holes are respectively provided are overlapped with the first and second seal plates,
these third and fourth seal plates comprise half beads that endlessly surround the oil drop holes, respectively, and that project in a direction toward each other to be mutually pressed, and
auxiliary beads that project in a direction toward each other to be mutually pressed are further formed outside of the respective half beads formed in the third and fourth seal plates.

3. The seal structure according to claim 1, wherein a third seal plate in which an oil drop hole is perforated is overlapped with the second seal plate, a half bead and an auxiliary bead that endlessly surround the oil drop hole are formed in this third seal plate, and the half bead and the auxiliary bead of this third seal plate are formed at a position overlapping with the half bead and the auxiliary bead of the second seal plate, respectively, so as to project in a direction away from the half bead and the auxiliary bead of the second seal plate.

4. The seal structure according to claim 1, wherein the first and second seal plates are coupled to each other around the oil drop hole.

5. A seal structure for an oil drop hole in a cylinder head gasket comprising at least two first and second seal plates in which the oil drop holes are respectively perforated, wherein
at a position overlapping with each other on the first and second seal plates, half beads that project in a direction away from each other to endlessly surround the oil drop holes are respectively formed, and
auxiliary beads that project in a direction away from each other are further formed at a position overlapping with each other outside of the respective half beads.

6. The seal structure according to claim 5, wherein
third and fourth seal plates in which oil drop holes are respectively provided are overlapped with the first and second seal plates,
these third and fourth seal plates comprise half beads at a position overlapping with each other that project in a direction away from each other to endlessly surround the oil drop holes, respectively, and
auxiliary beads that project in a direction away from each other are further formed at a position overlapping with each other outside of the respective half beads formed in the third and fourth seal plates.

7. The seal structure according to claim 5, wherein a third seal plate in which an oil drop hole is perforated is overlapped with the second seal plate, a half bead and an auxiliary bead that endlessly surround the oil drop hole are formed in this third seal plate, and the half bead and the auxiliary bead of this third seal plate are formed at position overlapping with the half bead and the auxiliary bead of the second seal plate, respectively, so as to project in a direction toward the half bead and the auxiliary bead of the second seal plate, respectively.

8. The seal structure according to claim 5, wherein the first and second seal plates are coupled to each other at a position outside of the auxiliary beads.

9. The seal structure according to claim 1, wherein the auxiliary bead is formed at a position outside of the cylinder head gasket from the oil drop hole.

10. The seal structure according to claim 9, wherein in the respective seal plates bolt holes are perforated through which fastening bolts that couples a cylinder head and a cylinder block are inserted, the oil drop hole is formed at a position outside of the cylinder head gasket from these bolt holes, and the auxiliary bead is formed at a position outside of the cylinder head gasket from this oil drop hole.

11. The seal structure according to claim 1, wherein in the respective seal plates bolt holes are perforated through which fastening bolts that couples a cylinder head and a cylinder block are inserted, and in at least any of the half beads, a portion far from the bolt holes projects more than a portion near them.

12. The seal structure according to claim 1, wherein in the respective seal plates bolt holes are perforated through which fastening bolts that couples a cylinder head and a cylinder block are inserted, and in at least any of the half beads, a width of a portion far from the bolt holes is formed larger than that of a portion near them.

13. The seal structure according to claim 1, wherein a cross section of the auxiliary bead is formed to be semicircular.

14. The seal structure according to claim 1, wherein a cross section of the auxiliary bead is formed to be U-shaped.

15. The seal structure according to claim 1, wherein a cross section of the auxiliary bead is formed to be M-shaped.

16. The seal structure according to claim 1, wherein an inside of the auxiliary bead is filled with a filling material, such as a resin or rubber.
